(19) United States
(12) Patent Application Publication
(10) Pub. No.: US 2006/0077106 A1
(43) Pub. Date: Apr. 13, 2006

(54) Antenna module for portable wireless terminal

(75) Inventor: Gie-Sang Park, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD, Suwonsi (KR)

(21) Appl. No.: 11/242,185

(22) Filed: Oct. 3, 2005

(30) Foreign Application Priority Data
Oct. 8, 2004 (KR) 10-2004-0080168

(51) Int. Cl. H01Q 1/24

(52) U.S. Cl. 343/702

(57) ABSTRACT

An antenna module for a portable wireless terminal is provided. In the antenna module, a feed part is electrically connected to an RF connector of a mainboard, and a conductive layer is formed at the mainboard and is used as a ground of the mainboard. A ground element is formed in a shape having a predetermined width and a predetermined length based on features of the terminal. The ground element electrically connects the feed part to the conductive layer.

### PRIORITY

This application claims priority under 35 U.S.C. §119 to an application entitled “Antenna Module For Portable Wireless Terminal” filed in the Korean Intellectual Property Office on Oct. 8, 2004 and assigned Ser. No. 2004-0080168, the contents of which are incorporated herein by reference.

### BACKGROUND OF THE INVENTION

1. Field of the Invention

The present invention relates to an antenna module for a portable wireless terminal, and more particularly to a monopole antenna module for a portable wireless terminal, including a ground element installed in a feed part of the antenna module which is grounded to a mainboard of the terminal for improving the antenna's performance.

2. Background of the Prior Art

Recently portable wireless terminals such as Personal Communication Systems (PCS), Global Positioning Systems (GPS), Personal Digital Assistant (PDA), cellular phones and wireless notebook computers, have been widely used. Since their introduction, these terminals have evolved into smaller and slimmer devices. Additionally, these terminals are required to have various functions. Therefore, in order to satisfy users' desires, the design of the terminal is focused on a size reduction while maintaining or improving the functions.

The portable wireless terminals include an antenna module for a radio communication. The antenna module can be classified into an external type and a built-in type. The external antenna module is installed in a portable wireless terminal in such a manner that it protrudes from the terminal body, and the built-in antenna module is installed in a mainboard of a portable wireless terminal without any external protrusion. Further, the external antenna module can be classified into a dipole antenna module having a feed part and a ground part and a monopole antenna module having a feed part. The built-in antenna module can be classified in the same way. The built-in antenna module is more widely used than the external antenna module because of its portability and external appearance.

The monopole antenna has a feed part electrically connected to a feed pad of a mainboard. Though the performance of the antenna is proportional to the size of the antenna, a large antenna makes the terminal bigger. Therefore, there is a need for an antenna that can improve radiation performance without increasing its size and reduce a specific absorption rate (SAR).

### SUMMARY OF THE INVENTION

The present invention provides an antenna module for a portable wireless terminal, which can improve radiation performance without increasing the size of the terminal.

Also, the present invention provides an antenna module for a portable wireless terminal, which can improve performance while maintaining a slim and lightweight terminal.

Further, the present invention provides a portable wireless terminal with a monopole antenna module, in which a ground element is provided to improve the performance of the antenna.

According to an aspect of the present invention, an antenna module for a portable wireless terminal includes a feed part electrically connected to an RF (radio frequency) connector of a mainboard; a conductive layer formed at the mainboard and used as a ground of the mainboard; and a ground element having a predetermined width and a predetermined length based on features of the terminal, the ground element electrically connecting the feed part to the conductive layer.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a portable wireless terminal which may utilize the antenna of the present invention; and

FIG. 2 is a partially exploded perspective view of an antenna according to the present invention.

### DETAILED DESCRIPTION OF THE PREFERRED EMBODIMENTS

Reference will now be made in detail to the preferred embodiments of the present invention, examples of which are illustrated in the accompanying drawings. In addition, when it is determined that the subject of the invention may be ambiguous by a detailed description, the detailed description will be omitted.

Though a monopole-type built-in antenna module is illustrated in the drawings, the present invention can also be applied to a monopole-type external antenna module, a dipole-type built-in antenna module, and a dipole-type external antenna module. Further, though a folder-type terminal is illustrated, the present invention can also be applied to various types of terminals, such as, for example, a slide type and a bar type terminal.

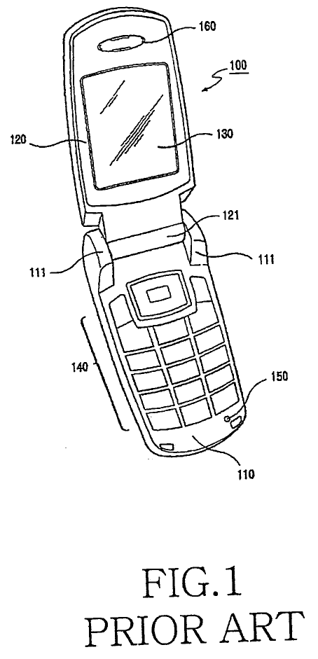

Referring to FIG. 1, a portable wireless terminal 100 includes a main body 110, a folder 120 rotatably coupled to the main body 110, and a hinge module (not shown) enabling the folder 120 to rotate at a predetermined angle (generally about 130-140°) with respect to the main body 110. The hinge module is installed in a center hinge arm 121 of the folder 120, which is a sub body. A dummy of a hinge shaft protrudes from an end of the hinge module and is fixed to one of side hinge arms 111 formed on the main body 110. In this manner, the terminal is able to be opened and closed.

The main body 110 includes a keypad assembly 140 as a data input device and a microphone 150 under the keypad assembly 140 to transmit voice signals to the other party. The keypad assembly 140 may include a navigation button. Also, the folder 120 includes a display 130 as a data output device and an earpiece 160 above the display 130 to output the other party's voice. Preferably, the display 130 may be a wide color LCD having hundreds of thousands to millions of pixels. In addition, the terminal 100 may include an external LCD module at an outer surface of the folder and a camera above the external LCD module for taking a picture.

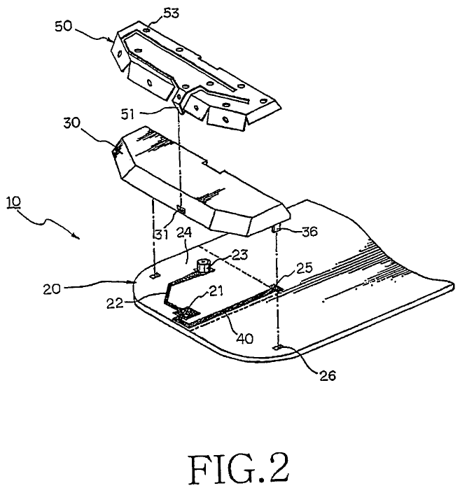

Referring to FIG. 2, a radiator 50 is mounted on a mainboard 20. The radiator 50 can be directly mounted on the mainboard 20, or as shown in FIG. 2, the radiator 50 can be mounted on a bracket 30 disposed on the mainboard 20. In this case, the radiator 50 can be fixed to the bracket 30 through a plurality of holes 53 by any suitable means, such as hot melt adhesion or ultrasonic welding. A feed pin 51 projects downwardly from a portion of the radiator 50. The feed pin 51 may be electrically connected to a feed part 21 formed on the mainboard 20. Further, the bracket 30 includes fixing protrusions 36 projected downwardly, and the mainboard 20 includes fixing holes 26 corresponding to the fixing protrusions 36. The bracket 30 can be fixed to the mainboard 20 by any suitable means, preferably by tightly inserting the fixing protrusions 36 into the fixing holes 26.

The feed part 21 of the mainboard 20 is electrically connected through a predetermined pattern 22 to an RF connector 23, which is disposed adjacent to the feed part 21. Accordingly, the pattern 22 and the feed part 21 are not formed on a ground, which is a conductive layer 25 formed in fabricating the mainboard 20. That is, the conductive layer 25 is not formed at a region 24 (enclosed by a dashed line in FIG. 2), and a ground element 40 is formed or mounted at the region 24 of the mainboard 20. The ground element 40 has a first end and a second end that are electrically connected to the feed part 21 and the conductive layer 25, respectively. The ground element 40 may be a conductive pattern that is formed in fabricating the mainboard 20. However, the present invention is not limited to this conductive layer. That is, conductors, such as a conductive metal and a flexible printed circuit (FPC), can be used as the ground element 40. In this case, the conductive metal or the FPC can be fixed to the mainboard 20 by any suitable means, such as soldering, conductive adhesive or bonding (including a bonding with conductive foam). In addition, the FPC may be fixed to the mainboard 20 after removing its coating to expose its conductive layer. The shape of the ground element 40 is not limited to the shape shown in FIG. 2. The shape of the ground element 40 may be designed to attain desirable performance when the antenna module is matched.

Radiation sensitivity and power of the antenna module without the ground element is given in Table 1 below, and radiation sensitivity and power of the antenna module with the ground element is given in Table 2 below, for both the Global System for Mobile (GSM) Communication and Digital Communication System (DCS) bands. Azimuth radiation patterns of the antenna module are measured at 45° scale and then average values are used for other angles to obtain the radiation sensitivity and power in the Tables below.

TABLE 1

| | | Folder open | | | | Folder closed | | | |
|---|---|---|---|---|---|---|---|---|---|
| | | Rx_sensitivity | | Tx_power | | Rx_sensitivity | | Tx_power | |
| Band | Channel | Max | Avg. | Max | Avg. | Max | Avg. | Max | Avg. |
| GSM | Low | −107 | −106.1 | 27.6 | 26.8 | −104 | −102.5 | 23.3 | 22.4 |
| | Middle | −106 | −104.8 | 29.4 | 28.1 | −104 | −101.9 | 25.4 | 24.1 |
| | High | −104 | −102.8 | 30.5 | 29.4 | −102 | −100 | 27.7 | 26.4 |
| | Avg. | −105.7 | −104.6 | 29.2 | 28.1 | −103.3 | −101.5 | 25.5 | 24.3 |
| DCS | Low | −108 | −104 | 26 | 21.2 | −103 | −101.5 | 22.9 | 21.9 |
| | Middle | −106 | −102.9 | 26.3 | 21.2 | −102 | −98.6 | 22.6 | 21.5 |
| | High | −102 | −100.8 | 25.9 | 22.4 | −102 | −94.6 | 23.3 | 21.7 |
| | Avg. | −105.3 | −102.6 | 26.1 | 21.6 | −102.3 | −98.2 | 22.9 | 21.7 |

TABLE 2

| | | Folder open | | | | Folder closed | | | |
|---|---|---|---|---|---|---|---|---|---|
| | | Rx_sensitivity | | Tx_power | | Rx_sensitivity | | Tx_power | |
| Band | Channel | Max | Avg. | Max | Avg. | Max | Avg. | Max | Avg. |
| GSM | Low | −108 | −107.4 | 30.9 | 30.2 | −104 | −102.8 | 26.4 | 25.6 |
| | Middle | −107 | −106.5 | 31.6 | 31.6 | −104 | −103.1 | 27.4 | 26.7 |
| | High | −106 | −104.1 | 31.6 | 30.4 | −102 | −101.3 | 27.7 | 26.9 |
| | Avg. | −107 | −106 | 31.4 | 30.5 | −103.3 | −102.4 | 27.2 | 26.4 |
| DCS | Low | −107 | −105.4 | 24.9 | 23.7 | −108 | −105.3 | 25.3 | 23.6 |
| | Middle | −108 | −104.3 | 25.9 | 22.7 | −106 | −102.5 | 25.7 | 23.9 |
| | High | −104 | −101.5 | 25.5 | 23.3 | −104 | −97.5 | 27.3 | 25.2 |
| | Avg. | −106.3 | −103.7 | 25.4 | 23.2 | −106 | −101.8 | 26.1 | 24.2 |

As shown in Tables 1 and 2, the radiation sensitivity and power are improved by about 1-2 dBm when the ground element is used. Therefore, it can be readily predicted that the antenna module of the present invention will have improved radiation performance at a weak electric field area compared with a related art antenna. That is, the antenna module of the present invention increases the performance of the wireless terminal.

As described above, the ground element is additionally provided in the antenna module of the present invention, such that the antenna module can have increased radiation performance.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. An antenna module for a portable wireless terminal, comprising:
a feed part electrically connected to an RF (Radio Frequency) connector of a mainboard;
a conductive layer formed on the mainboard and used as a ground of the mainboard; and
a ground element having a predetermined width and length, the ground element electrically connecting the feed part to the conductive layer.

2. The antenna module of claim 1, wherein the antenna module is a monopole antenna module.

3. The antenna module of claim 1, wherein the ground element is a plate type metal conductor fixed to the mainboard.

4. The antenna module of claim 3, wherein the metal conductor is fixed to the mainboard by one of soldering, conductive adhesive, and conductive foam.

5. The antenna module of claim 1, wherein the ground element is a conductive pattern formed in a predetermined shape when the mainboard is fabricated.

6. The antenna module of claim 1, wherein the ground element is an FPC (Flexible Printed Circuit) having a coating removed to expose a conductive layer.

7. The antenna module of claim 1, wherein the feed part is formed at a position isolated from the conductive layer and is electrically connected through a predetermined pattern to the RF connector.

8. The antenna module of claim 7, wherein the ground element is isolated from the conductive layer, the ground element having a first end electrically connected to the feed part and a second end electrically grounded to the conductive layer.
